(19) United States
(12) Patent Application Publication
(10) Pub. No.: US 2014/0192150 A1
(43) Pub. Date: Jul. 10, 2014

(54) IMAGE PROCESSING DEVICE, METHOD FOR CONTROLLING IMAGE PROCESSING DEVICE, CONTROL PROGRAM, AND COMPUTER-READABLE RECORDING MEDIUM WHICH RECORDS THE CONTROL PROGRAM

(71) Applicant: Yuhji Tanaka, Osaka-shi (JP)

(72) Inventor: Yuhji Tanaka, Osaka-shi (JP)

(73) Assignee: SHARP KABUSHIKI KAISHA, Osaka-shi, Osaka (JP)

(21) Appl. No.: 14/122,280

(22) PCT Filed: May 30, 2012
(86) PCT No.: PCT/JP2012/064008

§ 371 Date: Nov. 26, 2013

(30) Foreign Application Priority Data
Jun. 2, 2011 (JP) 2011-124512

(51) Int. Cl. H04N 13/00; H04N 13/04

(52) U.S. Cl. CPC H04N 13/004; H04N 13/0456
USPC 348/43

(57) ABSTRACT

An image processing device (10a) that receives a plurality of individual images including at least two images that form a stereoscopic image and generates a display image displaying the plurality of input individual images simultaneously on a display unit. The image processing device includes an image conversion unit (111) that converts at least one image among the input images that form the stereoscopic image into a planar image, and an image generation unit (151) that generates the display image by synthesizing the planar image that has been converted by the image conversion unit (111) and an image among the plurality of input images that has not been converted into a planer image by the image conversion unit (111).

### TECHNICAL FIELD

The present invention relates to an image processing device that synthesizes a plurality of images, which include images to be combined, into one image for stereoscopic vision.

### BACKGROUND ART

In recent years, there has been a focus on display devices that display an image for stereoscopic vision (hereinafter referred to as a “stereoscopic display devices”). A number of methods for displaying an image for stereoscopic vision have been suggested, and a so-called frame sequential method has been widely used in normal television sets for households.

The frame sequential method will be described briefly with reference to FIG. 11. FIG. 11 is a schematic drawing that describes a frame sequential method by which images are combined to synthesize a stereoscopic vision. As shown in the drawing, in the frame sequential method, an image for the left eye and an image for the right eye are displayed alternately. Further, as shown in the drawing, the position of an object in the image for the right eye and the position of the object in the image for the left eye are displaced. Parallax is this displacement, and it is possible to obtain a stereoscopic vision as a result of the parallax.

Next, the parallax, the image for the right eye, and the image for the left eye will be described with reference to FIG. 12. FIG. 12 is a drawing that describes the relationship between the parallax and a set of positions of the image for the right eye and the image for the left eye. FIG. 12(a) and FIG. 12(b) show relationships of the above described positions when a virtual image that is perceived at a rear of a display surface, and FIG. 12(c) shows a relationship when a virtual image that is perceived at a front side of the display surface.

As shown in FIG. 12(a) and FIG. 12(b), in order to synthesize a virtual image (a depth effect) that is to be perceived at a rear of a display surface, that is, in order to show an object in an image as if the object is at a rear of the display surface, the position of the object in the image for the right eye is moved to the right, and the position of the object in the image for the left eye is moved to the left.

More specifically, in the image for the right eye, an object is displayed in a position in which a segment of a line that connects the right eye of a viewer and a position (the deep side of the display surface) in which the object is recognized, intersects the display surface, and in the image for the left eye, an object is displayed in a position in which a segment of a line that connects the left eye of a viewer and a position in which the object is recognized, intersects the display surface.

Therefore, the parallax (the amount of displacement between the position of an object in the image for the right eye and the position of an object in the left eye picture) illustrated in FIG. 12(a) in which the stereoscopic effect of the depth direction is large (the position at which an object is recognized is far from a viewer) is larger than that illustrated in FIG. 12(b).

Meanwhile, as shown by FIG. 12(c), in order to synthesize a virtual image (a projection effect) that is to be perceived at a front of a display surface, that is, in order to show an object in an image as if the object is in front of the display surface, the position of the object in the image for the right eye is moved to the left, and the position of the object in the image for the left eye is moved to the right. In other words, the relationship of the positions of the objects in an image for the right eye and an image for the left eye is changed in comparison with that in the cases of FIG. 12(a) and FIG. 12(b). In the case of FIG. 12(c), in the same manner as the cases of FIG. 12(a) and FIG. 12(b), the greater the stereoscopic effect (the position at which an object is recognized is near to a viewer) is, the greater the parallax is.

In recent years, stereoscopic display devices that simultaneously display a plurality of images for stereoscopic vision have been introduced. For example, PTL 1 discloses a stereoscopic display device which enables to show a plurality of stereoscopic images simultaneously with one device.

### CITATION LIST

### Patent Literature

PTL 1: Japanese Unexamined Patent Application Publication No. 2010-8501 (publication date: Jan. 14, 2010)

### SUMMARY OF INVENTION

### Technical Problem

FIG. 13 shows examples of simultaneously displaying two images for stereoscopic vision that are configured from an image for the right eye and an image for the left eye in a stereoscopic display devices of the related art. In the stereoscopic display devices of the related art, two images for stereoscopic vision T1 and T2 that are shown in FIG. 13(a) are set as inputs, and as shown in FIG. 13(b), a single image M that is obtained by synthesizing the images for stereoscopic vision T1 and T2, is displayed.

Considering this, in a case in which a plurality of images for stereoscopic vision are generated by capturing images with different conditions, there is a possibility that the parallax will differ between the plurality of images for stereoscopic vision. For example, a state in which the parallax between the plurality of images for stereoscopic vision differs is attained depending on distance of a position at which infinity is set from a display surface at which infinity is set. In addition, even if images for stereoscopic vision that are generated by capturing images with identical conditions are used, in a case in which the display size is enlarged or reduced, the parallax is also enlarged or reduced, and as a result thereof, a state in which the parallax between the plurality of images for stereoscopic vision differs is attained.

Further, if a plurality of images for stereoscopic vision in which the parallax differs are displayed simultaneously, since the depth effect and the projection effect of the respective images for stereoscopic vision differ from each other, the images for stereoscopic vision that are displayed simultaneously become unnatural or unpleasant images as a whole, and as a result thereof, there is a problem that a viewer feels a sense of discomfort.

More specifically, there is a problem that the distance in depth according to the image looks different regardless of the fact that the position of infinity differs, and people are displayed at the same size.

The related art does not take the abovementioned problems into consideration, and PTL 1 and the like do not disclose technology for solving these problems.

The present invention was devised in the light of the abovementioned problems, and an object thereof is to provide an image processing device that reduces the unpleasant feeling and sense of discomfort that is generated when displaying a plurality of image for stereoscopic vision simultaneously.

### Solution to Problem

In order to solve the abovementioned problems, the present invention provides an image processing device that receives a plurality of individual images including at least two images that form a stereoscopic image and generates a display displaying the plurality of input individual images simultaneously on a display unit. The image processing device includes image conversion means that converts at least one image among the input images that form the stereoscopic image into a planar image; and image generation means that generates the display image by synthesizing the planar image that has been converted by the image conversion means and an image among the plurality of input images that has not been converted into a planar image by the image conversion means.

In addition, according to the present invention, a method for controlling an image processing device that receives a plurality of individual images including at least two images that form a stereoscopic image and generates a display image displaying the plurality of input individual images simultaneously on a display unit. The controlling method includes an image conversion step of converting at least one image among the input images that form the stereoscopic image into a planar image; and an image generation step of generating the display image by synthesizing the planar image that has been converted in the image conversion step and an image among the plurality of input images that has not been converted into a planar image in the image conversion step.

According to the abovementioned configuration, a plurality of images that include at least two images for stereoscopic vision are input, and at least one of the image for stereoscopic vision is converted into an image for planar vision. Further, an image for display is generated by synthesizing the converted image for planar vision and an image among the input plurality of images that has not been converted into an image for planar vision by the image conversion means.

Accordingly, instead of all of the input images for stereoscopic vision being displayed as images for stereoscopic vision as they are, only a portion thereof is displayed as image for stereoscopic vision as they are, and other images are displayed as images for planar vision.

Therefore, it is possible to exhibit an effect of reducing the occurrence of unnatural or unpleasant displays that are caused by the parallax between the plurality of images for stereoscopic vision not coinciding, and reducing the feeling of discomfort that a viewer would feel in the related art.

### Advantageous Effects of Invention

As described above, an image processing device according to the present invention that sets a plurality of images that include at least two images for stereoscopic vision as the input thereof, generates an image for display that displays the input plurality of images simultaneously on a display unit including image conversion means that converts at least one image among the input images for stereoscopic vision into an image for planar vision; and image generation means that generates the image for display by synthesizing the image for planar vision that is converted in the image conversion means and an image among the plurality of input images that has not been converted into an image for planar vision by the image conversion means.

In addition, according to the present invention, a control method for an image processing device that sets a plurality of images that include at least two images for stereoscopic vision as the input thereof, and generates an image for display that displays the input plurality of images simultaneously on a display unit, includes an image conversion step of converting at least one image among the input images for stereoscopic vision into an image for planar vision; and an image generation step of generating the image for display by synthesizing the image for planar vision that is converted in the image conversion step and an image among the input images that has not been converted into an image for planar vision by the image conversion step.

Therefore, it is possible to exhibit an effect of reducing the occurrence of unnatural or unpleasant displays that are caused by the parallax between the plurality of images for stereoscopic vision not coinciding, and reducing the feeling of discomfort that a viewer would feel in the related art.

It is considered that the other objects, features and superior points of the present invention can be understood from the statements shown below. In addition, it is considered that the advantages of the present invention are evident from the following descriptions that reference the appended drawings.

### BRIEF DESCRIPTION OF DRAWINGS

FIG. 1 is a block diagram that shows a configuration of an image processing device according to an embodiment of the present invention.

FIG. 2 is a schematic drawing that shows images for display that are generated by the image processing devices according to each embodiment of the present invention. FIG. 2(a) is a schematic drawing that shows two images for stereoscopic vision that are to be input into the image processing device. FIG. 2(b) is a schematic drawing that shows images for display that are generated from the images for stereoscopic vision that are shown in FIG. 2(a).

FIG. 3 is a block diagram that shows a configuration of a conversion unit that is included in the image processing device that is shown in FIG. 1.

FIG. 4 is a flowchart that shows a flow of processes in the image processing device that is shown in FIG. 1 until an image for display is obtained.

FIG. 5 is a block diagram that shows a modification example of the image processing device that is shown in FIG. 1.

FIG. 6 is a block diagram that shows a configuration of a picture clipping unit that is included in the modification example of the image processing device that is shown in FIG. 5.

FIG. 7 is a block diagram that shows a configuration of an image processing device according to another embodiment of the present invention.

FIG. 8 is a schematic drawing that shows images for display that are generated by the image processing device that is shown in FIG. 7. FIG. 8(a) is a schematic drawing that shows two images for stereoscopic vision that are to be input into the image processing device. FIG. 8(b) is a schematic drawing that shows images for display, that with the larger display size being an image that is displayed as an image for stereoscopic vision as it is, and that with the smaller display size being an image that is displayed as an image for planar vision. FIG. 8(c) is a schematic drawing that shows images for display, that with the larger display size being an image that is displayed as an image for stereoscopic vision as it is, and that with the smaller display size being an image that is displayed as an image for planar vision. FIG. 8(d) is a schematic drawing that shows images for display regardless of display position and mutual overlap of images, that with the larger display size being an image that is displayed as an image for stereoscopic vision as it is, and that with the smaller display size being an image that is displayed as an image for planar vision.

FIG. 9 is a block diagram that shows a configuration of an image processing device according to still another embodiment of the present invention.

FIG. 10 is a schematic drawing that shows images for display that are generated by the image processing device that is shown in FIG. 9. FIG. 10(a) is a schematic drawing that shows an example of when an operation that sets the display region is not received by an operation reception unit. FIG. 10(b) is a schematic drawing that shows a circumstance after the example shown in FIG. 10(a), and immediately after an operation that sets the display region is received by the operation reception unit. FIG. 10(c) is a schematic drawing that shows a circumstance after the example shown in FIG. 10(b), and during a period in which the display region is being changed as a result of the operation. FIG. 10(d) is a schematic drawing that shows a circumstance after the example shown in FIG. 10(b), and during a period in which the display region is being changed as a result of the operation. FIG. 10(e) is a schematic drawing that shows a circumstance after the example shown in FIG. 10(d), and after the operation has been completed.

FIG. 11 is a schematic drawing that shows a circumstance in a frame sequential method in which an image for the right eye and an image for the left eye that configure an image for stereoscopic vision are displayed alternately.

FIG. 12 is a drawing that describes the relationship between a parallax and a set of positions of an image for the right eye and an image for the left eye. FIG. 12(a) is a schematic drawing that describes a relationship of the positions when a virtual image is perceived at a rear of a display surface. FIG. 12(b) is a schematic drawing that describes a relationship of the positions when a virtual image is perceived at a rear of the display surface. FIG. 12(c) is a schematic drawing that describes a relationship of the positions when a virtual image is perceived at a front of the display surface.

FIG. 13 is a schematic drawing that shows circumstances in which two images for stereoscopic vision are displayed simultaneously. FIG. 13(a) is a schematic drawing that shows two images for stereoscopic vision that are to be input. FIG. 13(b) is a schematic drawing that shows a single image that is obtained by synthesizing the two images for stereoscopic vision that are input.

### DESCRIPTION OF EMBODIMENTS

### Summary of Image Processing Device

Firstly, a general description of an image processing device 10 according to each embodiment will be given. Additionally, in the present specification, when the image processing devices 10a to 10d of each embodiment, which will be described later, are referred to without reference to a particular drawing, they are simply referred to as the “image processing device 10”.

The image processing device 10 is a device that sets a plurality of images that include at least two images for stereoscopic vision (3D images) as the input thereof, and carries out a process of synthesizing the input plurality of images into a single image in order to achieve simultaneous display thereof. The single synthesized image is referred to as an image for display below.

Input images may include at least two image for stereoscopic vision (3D images), but the number of images for stereoscopic vision and the number of images for planar vision (2D images) that are included in the input images are not limited. Additionally, the images for stereoscopic vision are images that are configured by an image for the left eye for forming an image for the left eye and an image for the right eye for forming an image for the right eye, and can be viewed stereoscopically by a viewer when displayed.

Further, the image processing device 10 converts at least one image among the input image for stereoscopic vision into an image for planar vision, and generates the image for display. That is, instead of all of the input images for stereoscopic vision being displayed as images for stereoscopic vision as they are, only a portion thereof is displayed as image for stereoscopic vision, and other images are displayed as images for planar vision. As a result of this configuration, the occurrence of unnatural or unpleasant displays that are caused by the parallax between the plurality of images for stereoscopic vision not coinciding, is reduced. As a result of this, it is possible to reduce the feeling of discomfort that a viewer would feel in the related art.

In particular, it is most preferable that the image processing device 10 convert all but any one of the images among the input images for stereoscopic vision into images for planar vision, and generate an image for display. In such a case, only one image among the input images input as images for stereoscopic vision is displayed as an image for stereoscopic vision, and other images are displayed as images for planar vision. Therefore, unnatural or unpleasant displays that are caused by the parallax between the plurality of images for stereoscopic vision not coinciding, do not occur at all. As a result of this, it is possible to eliminate the feeling of discomfort that a viewer would feel in the related art.

Additionally, with respect to deciding which image among the input images for stereoscopic vision will be displayed as an image for stereoscopic vision, there are various methods that can be considered. For example, a method in which an image for stereoscopic vision in which a difference between the largest value and the smallest value of the parallax is less than a fixed value, is displayed as an image for stereoscopic vision, could be considered. In addition, as another method, a method in which an image for stereoscopic vision that is a predetermined number from the first image for stereoscopic vision among images for stereoscopic vision that fulfill predetermined conditions, is displayed as an image for stereoscopic vision, could be considered.

### (Aspect of Display)

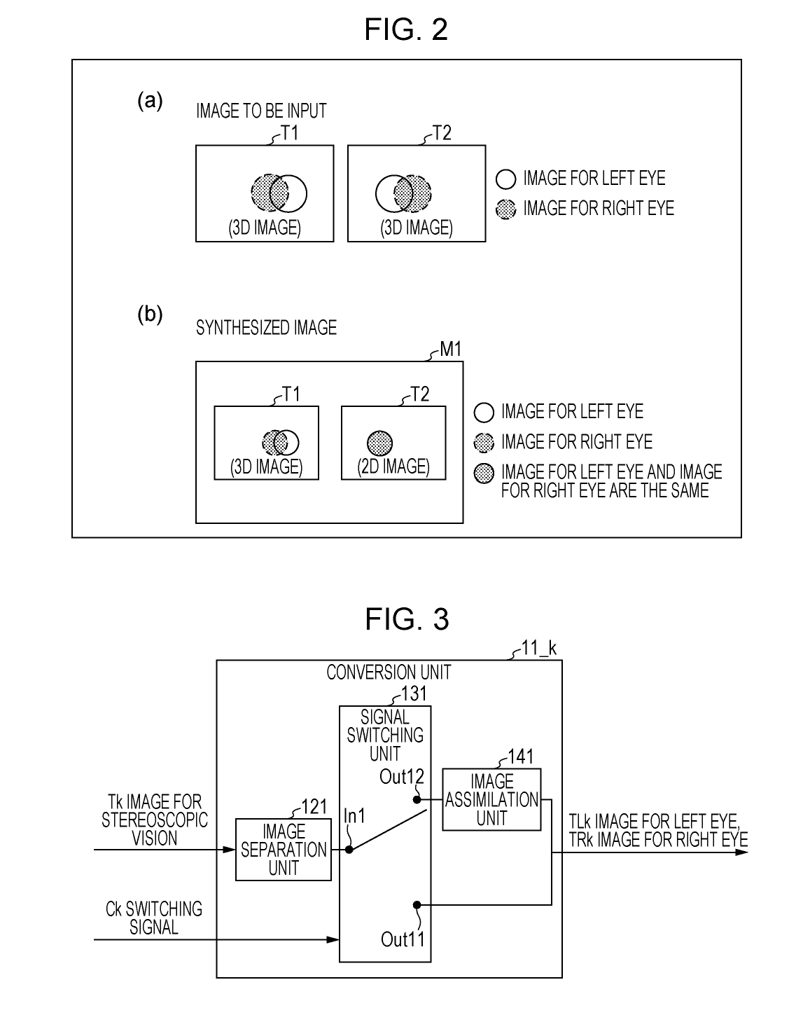

FIG. 2 shows examples of images for display that are generated by the image processing device 10. FIG. 2 is a schematic drawing that shows images for display that are generated by the image processing device 10. In this example, the image processing device 10 sets two images for stereoscopic vision T1 and T2 that are shown in FIG. 2(a) as the input thereof, and, as shown in FIG. 2(b), synthesizes an image for display M1 by displaying the image for stereoscopic vision T1 as an image for stereoscopic vision as it is, and converting the image for stereoscopic vision T2 into an image for planar vision TP.

Additionally, in the images for stereoscopic vision T1 and T2, an image that is shown with a solid line is an image for the left eye, and a shaded image that is shown with a dashed line is an image for the right eye. In addition, as will be described later, the image for planar vision TP that is converted from the image for stereoscopic vision T2 is an image in which the image for the left eye and the image for the right eye are the same.

### Embodiment 1

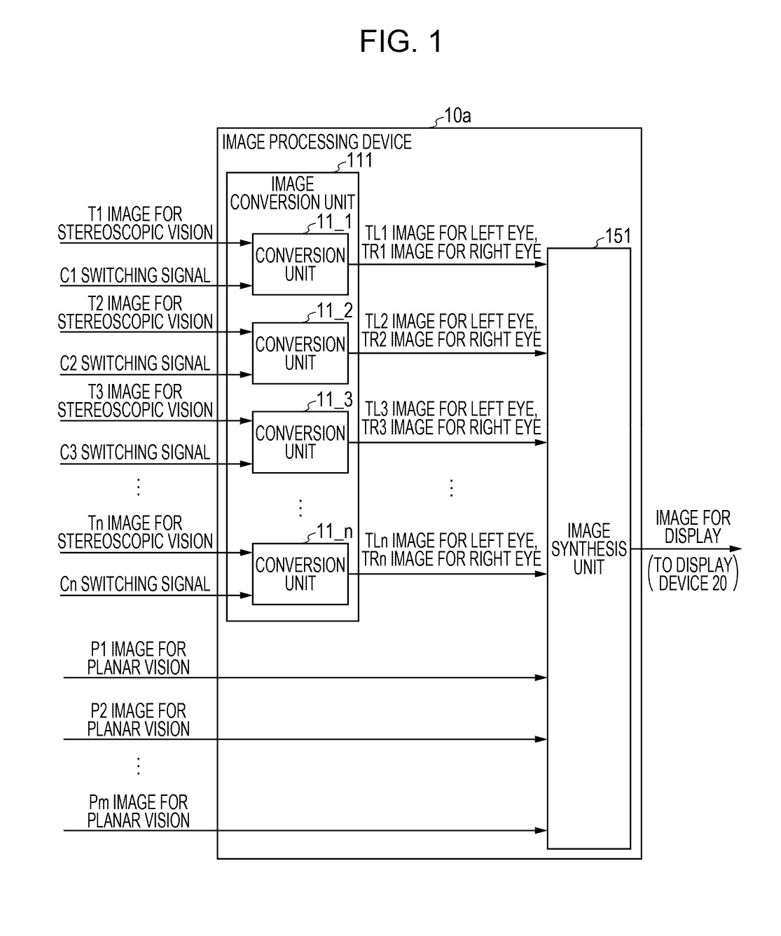

An embodiment of the present invention will be described below with reference to FIGS. 1, 3 and 6. The image processing device 10 according to the present embodiment is referred to as the image processing device 10a and the image processing device 10b.

### (Configuration of Image Processing Device)

A configuration of the image processing device 10a will be described with reference to FIG. 1. FIG. 1 is a block diagram that shows a summary of the configuration of the image processing device 10a. As shown in FIG. 1, the image processing device 10a is provided with at least an image conversion unit (image conversion means) 111 and an image synthesis unit (image generation means) 151. Additionally, each block of the image processing device 10a may be configured as hardware by a logic circuit formed on an integrated circuit (IC chip), and may be realized by software using a CPU (central processing unit).

The image conversion unit 111 performs processes that respectively outputs n (n is an integer of two or more) images for stereoscopic vision (T1, T2, . . . , Tn), that are input from the outside, as either an image for stereoscopic vision or as an image for planar vision. Therefore, the inside of the image conversion unit 111 is provided with conversion unit 11_1 to conversion unit 11_{—}n.

Conversion units 11_{—}k (k=1, 2, . . . , n) sets an image for stereoscopic vision Tk and a switching signal Ck that forms a pair with the image for stereoscopic vision Tk as the inputs thereof, and depending on the switching signal Ck, either outputs the image for stereoscopic vision Tk as an image for stereoscopic vision or outputs by converting the image for stereoscopic vision Tk into an image for planar vision.

The switching signal Ck is either a signal (hereinafter, referred to as a stereoscopic indication signal) that indicates output of an image for stereoscopic vision Tk, with which it forms a pair, as an image for stereoscopic vision, or a signal (hereinafter, referred to as a planar indication signal) that indicates output of an image for stereoscopic vision Tk, with which it forms a pair, by conversion into an image for planar vision.

However, at least one switching signal of switching signals C1 to Cn is a planar indication signal. A case in which only one of the switching signals C1 to Cn is a stereoscopic indication signal, and the remaining signals are all planar indication signals is most preferable.

Additionally, in the present embodiment, whether or not to set each switching signal Ck as a stereoscopic indication signal or to make the foregoing a planar indication signal is determined outside the image processing device 10a. For example, a configuration in which a switching signal Ck that is paired with an image for stereoscopic vision T_{K} that is specified by an operation received from a user such as a viewer through an input device (not shown in the drawings), is set as a stereoscopic indication signal, may be used.

Next, a detailed configuration of the conversion units 11_{—}k (k=1, 2, . . . , n) will described with reference to FIG. 3. FIG. 3 is a block diagram that shows a configuration of the conversion units 11_{—}k. As shown in FIG. 3, the conversion units 11_{—}k are provided with an image separation unit 121, a signal switching unit 131 and an image assimilation unit 141.

The image separation unit 121 separates an input image for stereoscopic vision Tk into an image for the left eye TLk and an image for the right eye TRk that configure the image for stereoscopic vision Tk, and respectively outputs the separated image for the left eye TLk and image for the right eye TRk to a connection point In1.

Next, the signal switching unit 131 is a switch that connects the connection point In1 to either a connection point Out11 or a connection point Out12 according to a switching signal Ck that is input. More specifically, the connection point In1 is connected to the connection point Out11 when the switching signal Ck is a stereoscopic indication signal. On the other hand, the connection point In1 is connected to the connection point Out12 when the switching signal Ck is a planar indication signal.

Next, the image assimilation unit 141 carries out a process on an input image for the left eye TLk and image for the right eye TRk that makes the two images into the same image (hereinafter, referred to as assimilation).

The method of assimilation may be any one of the following (A) to (C). (A) the image for the left eye TLk is replaced by an image that is the same as the image for the right eye TRk. (B) the image for the right eye TRk is replaced by an image that is the same as the image for the left eye TLk. (C) the image for the left eye TLk and the image for the right eye TRk are replaced with images that are generated from the image for the left eye TLk and the image for the right eye TRk.

Additionally, any one of (A) to (C) mentioned above may be selected depending on the display device of the image for stereoscopic vision that forms the conversion target. For example, in a case in which the display device has a display surface that is right-of-center, assimilation is performed using the method of (A) mentioned above. In addition, for example, in a case in which the display device has a display surface that is left-of-center, assimilation is performed using the method of (B) mentioned above. In addition, for example, in a case in which the display device has a display surface that is centrally-aligned, assimilation is performed using the method of (C) mentioned above.

Next, the image synthesis unit 151 will be described with reference to FIG. 1 again. At least images for the left eye TL1 to SLn and the images for the right eye TR1 to SRn that are respectively output from the conversion units 11_1 to 11_{—}n of the image conversion unit 111 are input to the image synthesis unit 151. In this case, the image synthesis unit 151 generated an image for display from the images for the left eye TL1 to SLn and the images for the right eye TR1 to SRn.

More specifically, the image synthesis unit 151 generates a single image for the left eye by synthesizing n images for the left eye TLk. In the same manner, the image synthesis unit 151 generates a single image for the right eye by synthesizing n images for the right eye TRk. An image that is configured by the single image for the left eye and the single image for the right eye that are generated is the image for display.

As a result of the abovementioned configuration, in a case in which at least one of the switching signals C1 to Cn is a planar indication signal, only a portion of the images input into the image processing device 10a are displayed as images for stereoscopic vision in the image for display that the image synthesis unit 151 generates, and other images are displayed as images for planar vision. In particular, in the most preferable case in which only one of the switching signals C1 to Cn is a stereoscopic indication signal, only one image among the images input into the image processing device 10a as image for stereoscopic vision is displayed as an image for stereoscopic vision in the image for display that the image synthesis unit 151 generates, and other images are displayed as images for planar vision.

In other words, the image synthesis unit 151 synthesizes an image for planar vision that is obtained by conversion using the image conversion unit 111, and an image among the plurality of images input into the image processing device 10a that has not been converted into an image for planar vision by the image conversion unit 111.

Given that, as shown in the drawing, m (m is an integer of one or more) images for planar vision (P1, P2, . . . , Pm) may be input into the image processing device 10a from the outside. In such a case, the image synthesis unit 151 generates an image for display from the images for the left eye TL1 to TLn and the images for the right eye TR1 to TRn in addition to the images for planar vision P1 to Pm.

Considering this, the image synthesis unit 151 respectively uses the same images for planar vision P1 to Pm as images for the left eye and as images for the right eye. In other words, respective images for planar vision Pr (r=1, 2, . . . , m) are copied and used as an image for the left eye PLr and an image for the right eye PRr.

Considering this, the image synthesis unit 151 generates a single image for the left eye by synthesizing n images for the left eye TLk and m images for the left eye PLr. In the same manner, the image synthesis unit 151 generates a single image for the right eye by synthesizing n images for the right eye TRk and m images for the right eye PRr. An image that is configured by the single image for the left eye and the single image for the right eye that are generated is the image for display.

In the abovementioned manner, the image synthesis unit 151 synthesizes an image for planar vision that is obtained by conversion using the image conversion unit 111, and an image among the plurality of images input into the image processing device 10a that has not been converted into an image for planar vision by the image conversion unit 111 (in other words, an image that was not converted into an image for planar vision by the image conversion unit 111 and an image for planar vision that was input into the image processing device 10a).

Additionally, display attributes that relate to the display size and display position of each image to be synthesized into an image for display may be set in advance, or may be set depending on an operation received from a user such as a viewer through an input device (not shown in the drawings).

Further, a display device 20 sets an image for display that the image synthesis unit 151 generates as the input thereof, and displays an image in which a plurality of images have been synthesized. The display device 20 may be any display device 20 provided that it is capable of displaying an image for stereoscopic vision.

Additionally, the display device 20 need not necessarily be provided as an external device, and may have a configuration of being provided inside the image processing device 10a. In other words, the image processing device 10a itself may be a device that is provided with a display unit that displays the image for display. In a case in which the display device 20 is an external device, the image synthesis unit 151 and the display device 20 is connected by a cable that performs picture transmission such as a D-terminal cable, an HDMI (High Definition Multimedia Interface) cable, an iLink cable, or a DVI (Digital Visual Interface) cable.

Additionally, as a method for mixed display of an image for stereoscopic vision and an image for planar vision, various methods can be considered, but a single example thereof will be described. If an image for stereoscopic vision for example, displays an image for the left eye and an image for the right eye alternately every 8.3 ms, and an image for planar vision is set as an image that is transmitted every 16.6 ms, it is possible to display the image for stereoscopic vision as an image for planar vision if display is performed by repeated the same image twice so that the same image is reflected in the right eye and the left eye. In such a case, firstly, memory is provided inside the image processing device 10, and each image that is input is temporarily recorded on the memory. More specifically, the image for the left eye and the image for the right eye of an image for stereoscopic vision are respectively stored at two different addresses. On the other hand, an image for planar vision is stored at one address. Considering this, when displaying as an image for stereoscopic vision, reading is performed alternately from the abovementioned two different addresses, and on the other hand, when displaying as an image for planar vision, reading is performed twice in succession from the one address. As a result of this configuration, it is possible to realize mixed display of an image for stereoscopic vision and an image for planar vision. In other words, it is possible to realize display of an image for stereoscopic vision as an image for planar vision and display of an image for planar vision as an image for planar vision by merely switching the reading position (address) of the memory.

### (Flow of Processes)

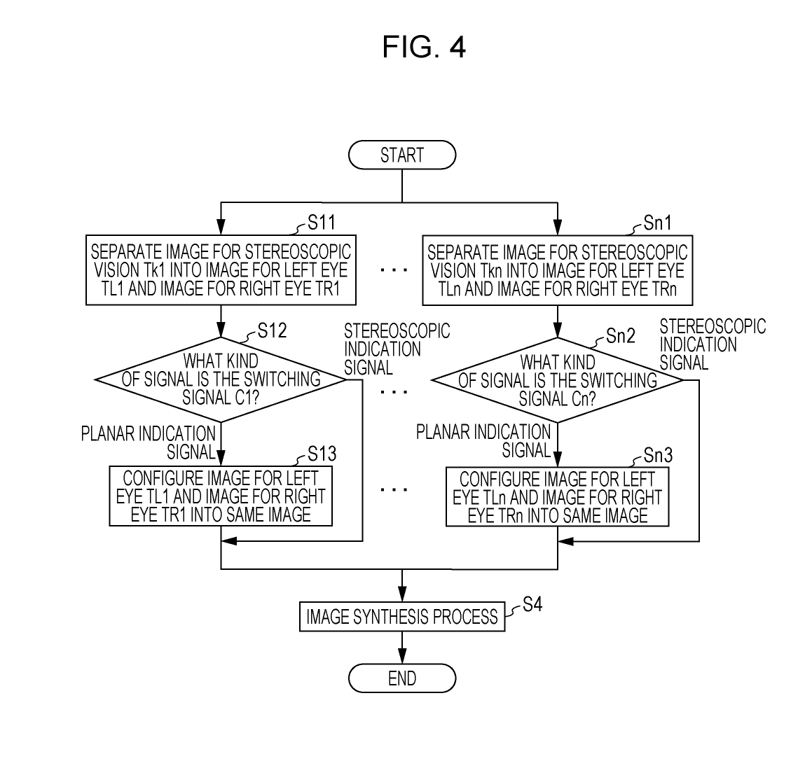

Next, a flow of the processes in the image processing device 10a until an image for display is obtained will be described with reference to FIG. 4. FIG. 4 is a flowchart that shows a flow of the processes in the image processing device 10a until an image for display is obtained.

Firstly, an input image for stereoscopic vision Tk is separated into an image for the left eye TLk and an image for the right eye TRk that configure the image for stereoscopic vision Tk by the image separation unit 121 in the conversion units 11_{—}k (k=1, 2, . . . , n) of the image conversion unit 111 (Step S11 to Sn1).

Next, each conversion unit 11_{—}k makes an image for the left eye TLk and an image for the right eye TRk into the same image using the image assimilation unit 141 (Step S13 to Sn3) when the switching signal Ck is a planar indication signal (“planar indication signal” in Step S12 to Sn2) (image conversion step). On the other hand, each conversion unit 11_{—}k skips Step S13 to Sn3 when the switching signal Ck is a stereoscopic indication signal (“stereoscopic indication signal” in Step S12 to Sn2).

Considering this, in the image synthesis unit 151, a single image for the left eye is generated by synthesizing n images for the left eye TLk, and a single image for the right eye is generated by synthesizing n images for the right eye TRk (Step S4) (image generation step). Additionally, in a case in which images for planar vision are input from the outside, as described above, an image for display is generated by including these images.

### (Effects)

In the manner described above, according to the image processing device 10a, the image conversion unit 111 outputs by converting at least one image among the n images for stereoscopic vision (T1, T2, . . . , Tn) that are input from the outside into an image for planar vision. Therefore, only a portion of the images input into the image processing device 10a as images for stereoscopic vision are displayed as images for stereoscopic vision in the image for display that is generated by the image synthesis unit 151.

In the most preferable case, the image conversion unit 111 outputs by converting all but any one of the images among the images for stereoscopic vision (T1, T2, . . . , Tn) that are input from the outside into images for planar vision. Therefore, a single image among the images that are input into the image processing device 10a as images for stereoscopic vision is displayed as an image for stereoscopic vision in the image for display that is generated by the image synthesis unit 151.

Therefore, it is possible to reduce or curtail a feeling of discomfort that is felt by a viewer that views the image for stereoscopic vision.

### Modification Example

The generation method of an image for display is not limited to the abovementioned configuration. For example, a configuration that generates an image for display by synthesizing an image for stereoscopic vision that is input from the outside, and an image in which a portion of the image for stereoscopic vision has been clipped out (extracted), can be considered.

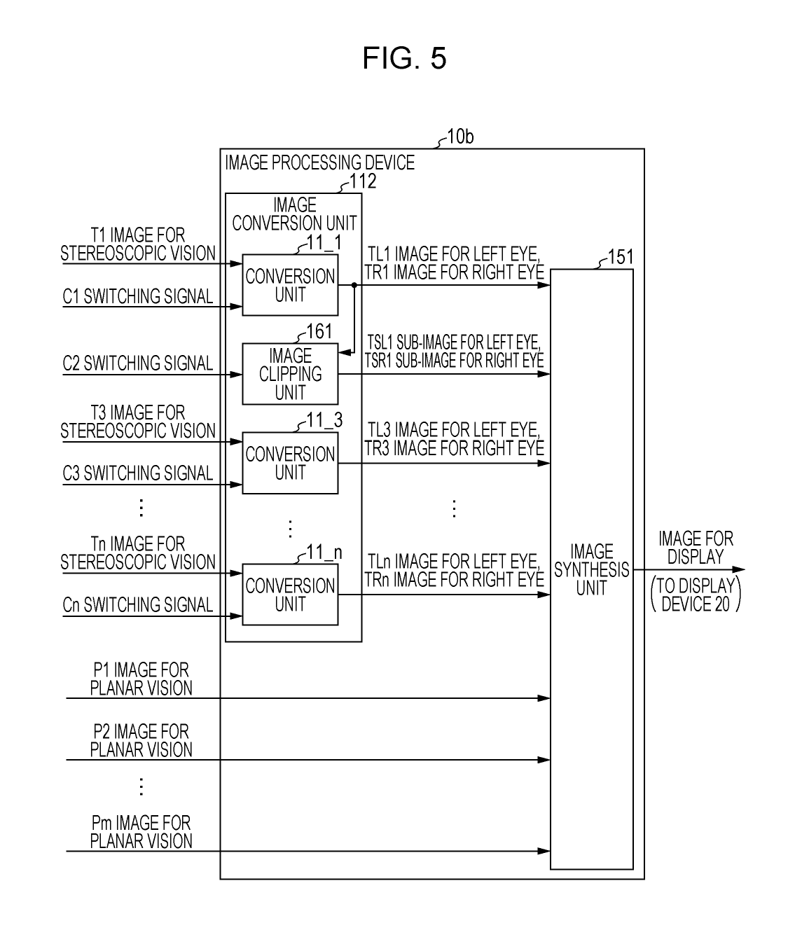

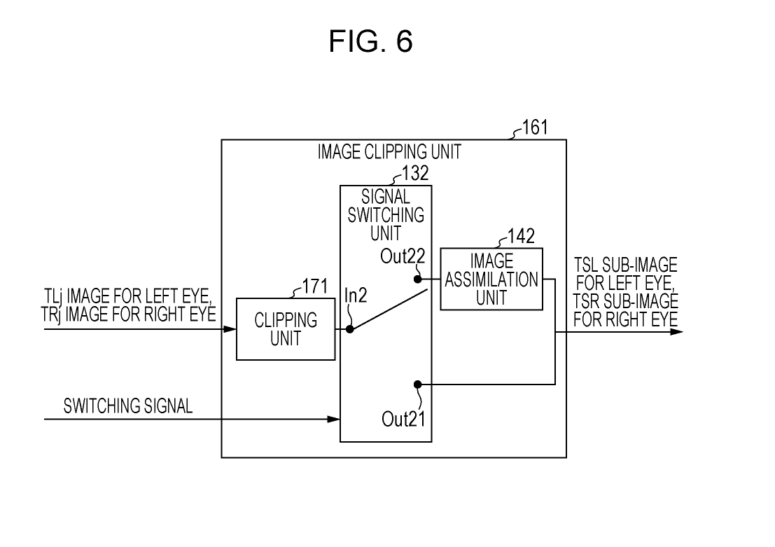

In such a case, the image processing device 10b that is provided with the abovementioned configuration will be described with reference to FIGS. 5 and 6. FIG. 5 is a block diagram that shows a summary of the configuration of the image processing device 10b. As shown in FIG. 5, the image processing device 10b is provided with at least an image conversion unit (image conversion means) 112 and the image synthesis unit 151.

The image conversion unit 112 has a configuration in which at least one of the conversion units 11_{—}k of the image conversion unit 111 is substituted with a picture clipping unit 161. In FIG. 5, a configuration example in which a conversion unit 11_2 of the image conversion unit 111 is substituted with the picture clipping unit 161.

The picture clipping unit 161 sets respective images for the left eye TLj and images for the right eye TRj that have been separated by the conversion unit 11_{—}j (j is an integer one or more and n or less, j is not k) as the inputs thereof. Further, a region of a part of the image for the left eye TLj is clipped out (extracted) as a sub-image for the left eye TSL. In addition, a region of a part of the image for the right eye TRj is clipped out (extracted) as a sub-image for the right eye TSR. Additionally, in FIG. 5, the image for the left eye TL1 and the image for the right eye TR1 that are separated by the conversion unit 11_1 are set as inputs.

Further, the picture clipping unit 161 outputs the extracted sub-image for the left eye TSL and sub-image for the right eye TSR as they are or outputs by converting the foregoing into images for planar vision according to a shifting signal to be input.

Next, a detailed configuration of the picture clipping unit 161 will be described with reference to FIG. 6. FIG. 6 is a block diagram that shows a configuration of the picture clipping unit 161. As shown in FIG. 6, the picture clipping unit 161 is provided with a clipping unit 171, a signal switching unit 132 and an image assimilation unit 142.

The clipping unit 171 respectively clips out a part of the input image for the left eye TLj and image for the right eye TRj, and, after the clipping, respectively outputs a sub-image for the left eye TSL and a sub-image for the right eye TSR to the connection point Int.

The signal switching unit 132 is a switch that connects the connection point Int to either a connection point Out21 or a connection point Out22 according to a switching signal that is input. More specifically, the connection point Int is connected to the connection point Out21 when the switching signal is a stereoscopic indication signal. On the other hand, the connection point Int is connected to the connection point Out22 when the switching signal is a planar indication signal.

The image assimilation unit 142 carries out a process on an input sub-image for the left eye TSL and sub-image for the right eye TSR that makes the two images into the same image. The method of assimilation is the same as that described above, and therefore description thereof is omitted.

### Embodiment 2

In the present embodiment, a configuration in which the decision of which switching signals C1 to Cn to set as a stereoscopic indication signal is made by the image processing device 10 will be described.

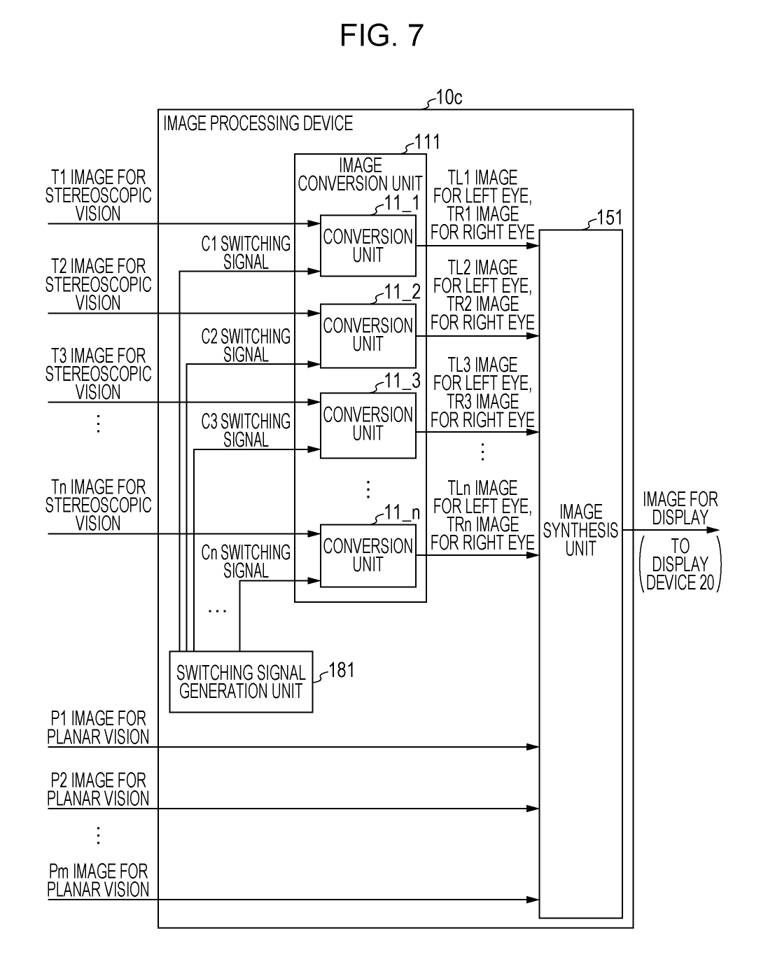

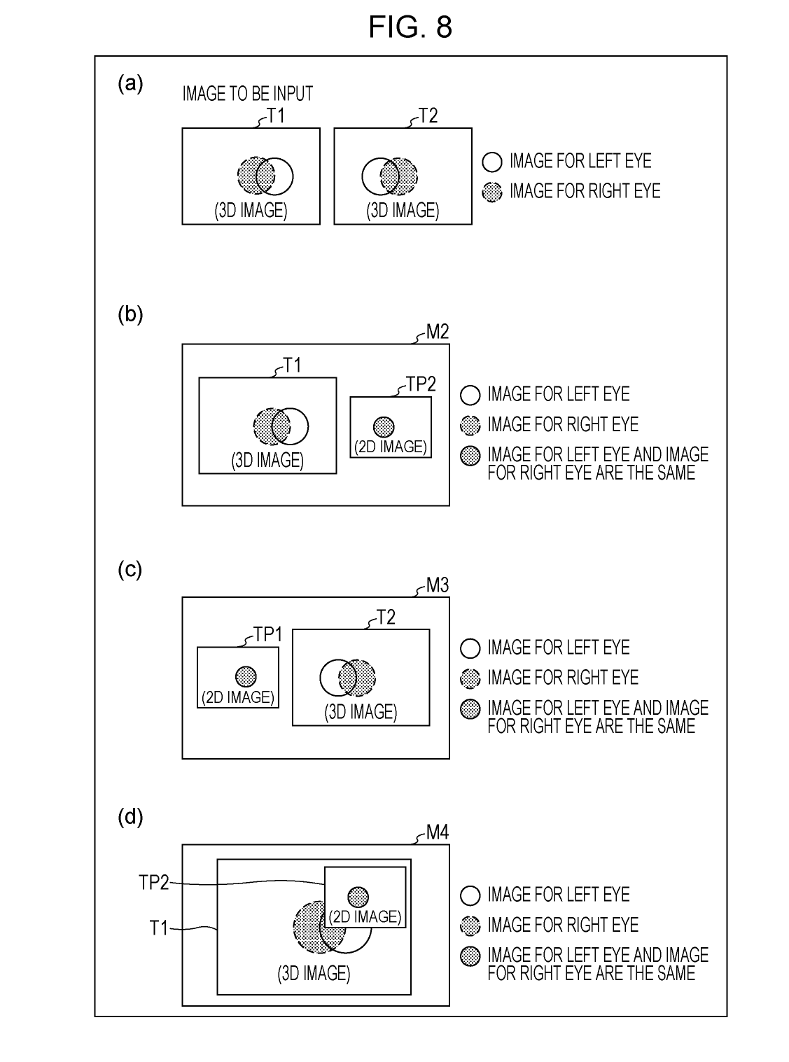

Another embodiment of the present invention will be described below with reference to FIGS. 7 and 8. The image processing device 10 according to the present embodiment is referred to as the image processing device 10c. Additionally, for the convenience of description, members that have the same function as each member shown in Embodiment 1 will be given the same reference numerals, and descriptions thereof will be omitted except in cases in which the descriptions are specifically mentioned.

### (Configuration of Image Processing Device)

A configuration of the image processing device 10c will be described with reference to FIG. 7. FIG. 7 is a block diagram that shows a summary of the configuration of the image processing device 10c. As shown in FIG. 7, the image processing device 10c is provided with at least an image conversion unit 111, an image synthesis unit 151 and a switching signal generation unit (attribute information acquisition means) 181.

The switching signal generation unit 181 acquires attribute information that is associated with the images for stereoscopic vision T1 to Tn, and in accordance with the acquired attribute information, either outputs the switching signals C1 to Cn as stereoscopic indication signals or outputs the foregoing as planar indication signals.

Examples of attribute information of an image for stereoscopic vision Tk (k=1, 2, . . . , n) include (i) the display size of the image for stereoscopic vision Tk (the area of the display region), (ii) content information (metadata) that is related to the image for stereoscopic vision Tk and the like.

The attribute information of the abovementioned (i) may be data that is extractable from a signal line that configures the image for stereoscopic vision Tk, or may be data that is transmitted from the outside separately from the image for stereoscopic vision Tk. In addition, the attribute information of the abovementioned (i) may be set in advance in a storage unit (not shown in the drawings) inside the image processing device 10, or may be set depending on an operation received from a user such as a viewer through an input device (not shown in the drawings).

Further, in a case of the attribute information of (i) indicated above, the image processing device 10c for example, displays a predetermined number of images for stereoscopic vision as images for stereoscopic vision in order from the images in the input images for stereoscopic vision Tk that have larger display sizes, and displays other images as images for planar vision. Therefore, the switching signal generation unit 181 respectively outputs switching signals that form pairs with the predetermined number of images for stereoscopic vision as stereoscopic indication signals in order from the images that have larger display sizes, and outputs other switching signals as planar indication signals.

It is most preferable that the image processing device 10c display only a single image (a main image) that has the largest display size among the input images for stereoscopic vision Tk as an image for stereoscopic vision, and display other images (sub-images) as images for planar vision. In this case, the switching signal generation unit 181 outputs a switching signal that forms a pair with the image that has the largest display size as a stereoscopic indication signal, and outputs other switching signals as planar indication signals.

On the other hand, the attribute information of the abovementioned (ii) assumes channel information and genres that are obtained from an EPG (Electronic Program Guide) that can be acquired from digital airwaves or the Internet.

Further, in a case of the attribute information of (ii) indicated above, the image processing device 10c for example, displays images for stereoscopic vision that have attribute information that matches predetermined conditions, as images for stereoscopic vision. Therefore, the switching signal generation unit 181 outputs switching signals that form pairs with images for stereoscopic vision that have attribute information that matches the abovementioned predetermined conditions as stereoscopic indication signals, and outputs other switching signals as planar indication signals. In a case in which there are several images for stereoscopic vision that have attribute information that matches the abovementioned predetermined conditions, a predetermined number of images for stereoscopic vision among images that are retrieved with high priority may be selected.

It is most preferable that the image processing device 10c display only a single image among images for stereoscopic vision that have attribute information that matches predetermined conditions, as an image for stereoscopic vision, and display other images as images for planar vision. In this case, the switching signal generation unit 181 outputs a switching signal that forms a pair with any image for stereoscopic vision that has attribute information that matches the abovementioned predetermined conditions as a stereoscopic indication signal, and outputs other switching signals as planar indication signals. Additionally, in a case in which there are a plurality of images for stereoscopic vision that have attribute information that matches the abovementioned predetermined conditions, the image that was retrieved first may be selected.

Additionally, the abovementioned predetermined conditions may be set in advance in a storage unit (not shown in the drawings) inside the image processing device 10c, or may be set depending on an operation received from a user such as a viewer through an input device (not shown in the drawings).

In particular, in a case in which the attribute information is a genre, as the abovementioned predetermined conditions, for example, if “sports” is set, it is possible to display a sports image as an image for stereoscopic vision, and display images other than sports images as images for planar vision.

Furthermore, the abovementioned predetermined conditions may be the preferred information of a user such as a viewer. Preferred information may be input by a user such as a viewer through an input device (not shown in the drawings), or may be generated through learning on the basis of operation history received from a user such as a viewer.

### (Aspect of Display)

FIG. 8 shows examples of images for display that are generated by the image processing device 10c. FIG. 8 is a drawing that schematically represents images for display that are generated by the image processing device 10c.

In this example, the image processing device 10c sets two images for stereoscopic vision T1 and T2 that are shown in FIG. 8(a), and have different display sizes as the input thereof, and generates an image for display such that the image with a larger display size is displayed as an image for stereoscopic vision as it are, and the image with a smaller display size is displayed as an image for planar vision (FIGS. 8(b) to 8(d)).

In a case in which the display size of the image for stereoscopic vision T1 is larger, as shown in FIG. 8(b), an image for display M2 is synthesized by setting the image for stereoscopic vision T1 as it is as an image for stereoscopic vision, and converting the image for stereoscopic vision T2 into an image for planar vision TP2.

On the other hand, in a case in which the display size of the image for stereoscopic vision T2 is larger, as shown in FIG. 8(c), an image for display M3 is synthesized by setting the image for stereoscopic vision T2 as it is as an image for stereoscopic vision, and converting the image for stereoscopic vision T1 into an image for planar vision TP1.

Additionally, it is not necessary to take the display position of the synthesized image and mutual overlap of images into account. For example, in a case in which the display size of the image for stereoscopic vision T1 is larger, as shown in FIG. 8(d), an image for display M4 is synthesized by setting the image for stereoscopic vision T1 as it is as an image for stereoscopic vision, and converting the image for stereoscopic vision T2 into an image for planar vision TP2 so that the images are respectively superimposed over one another.

### (Effects)

In the manner described above, according to the image processing device 10c, it is possible to decide which image is displayed as the image for stereoscopic vision according to attribute information of the images for stereoscopic vision in a case of synthesizing a single image in order to display a plurality of images that include images for stereoscopic vision simultaneously.

In a case in which the display size mentioned above is used as the attribute information, it is possible to display a main image that has a large display size as an image for stereoscopic vision, and display a sub-image that has a small display size as an image for planar vision.

### Modification Example

In addition to the method for determining an image that is displayed as an image for stereoscopic vision that uses the attribute information described above, a method that displays an image for stereoscopic vision among images for stereoscopic vision T1 to Tn for which the display position is close to a viewer as an image for stereoscopic vision can be considered.

In such a case, the image processing device 10c is further provided with a position detection unit 20 (not shown in the drawings) that detects the position of a viewer, an image of whom is captured using an image capture device such as a camera.

Further, the switching signal generation unit 181 outputs a switching signal that forms a pair with an image for stereoscopic vision that is displayed near to the position of a viewer that is detected using the position detection unit as a stereoscopic indication signal, and outputs other switching signals as planar indication signals.

It is most preferable that only an image for stereoscopic vision that is displayed closest to a viewer be displayed as an image for stereoscopic vision. In this case, the switching signal generation unit 181 outputs a switching signal that forms a pair with the image for stereoscopic vision that is displayed closest to a viewer as a stereoscopic indication signal, and outputs other switching signals as planar indication signals.

### Embodiment 3

In the present embodiment, a configuration in which all of the images for stereoscopic vision Tk are displayed as image for planar vision in a period in which the display region of each image (any one of the display size and the display position) that is synthesized in the image for display that is being displayed is being changed according to the operation of a user such as a viewer, will be described.

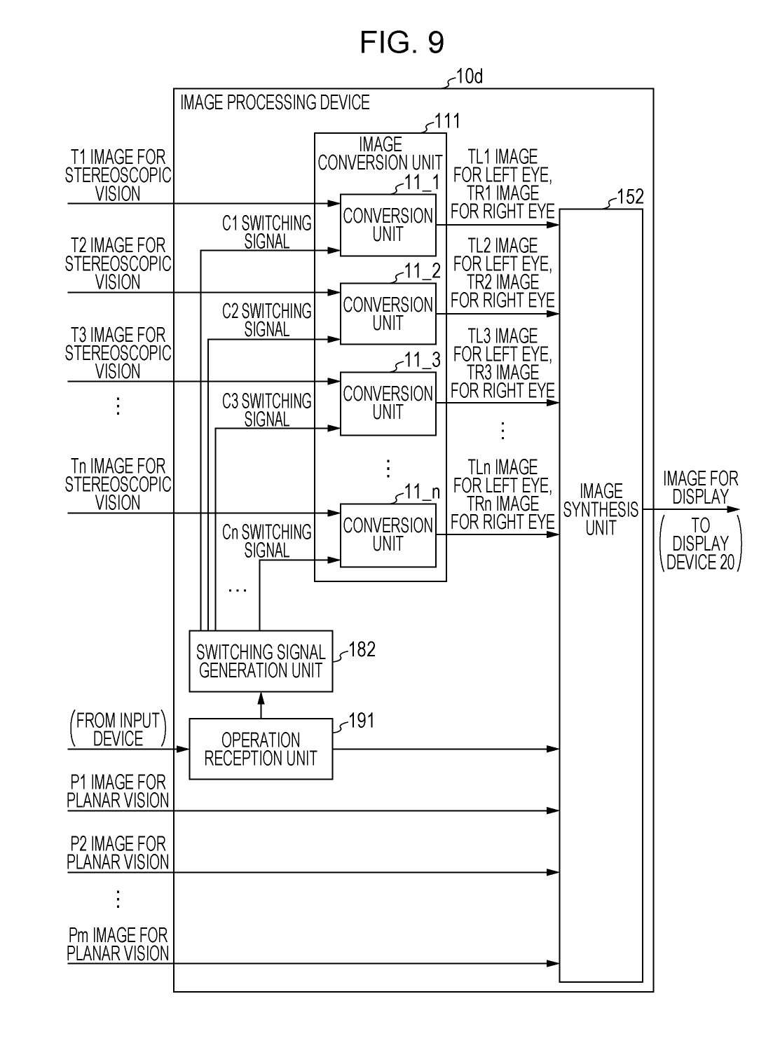

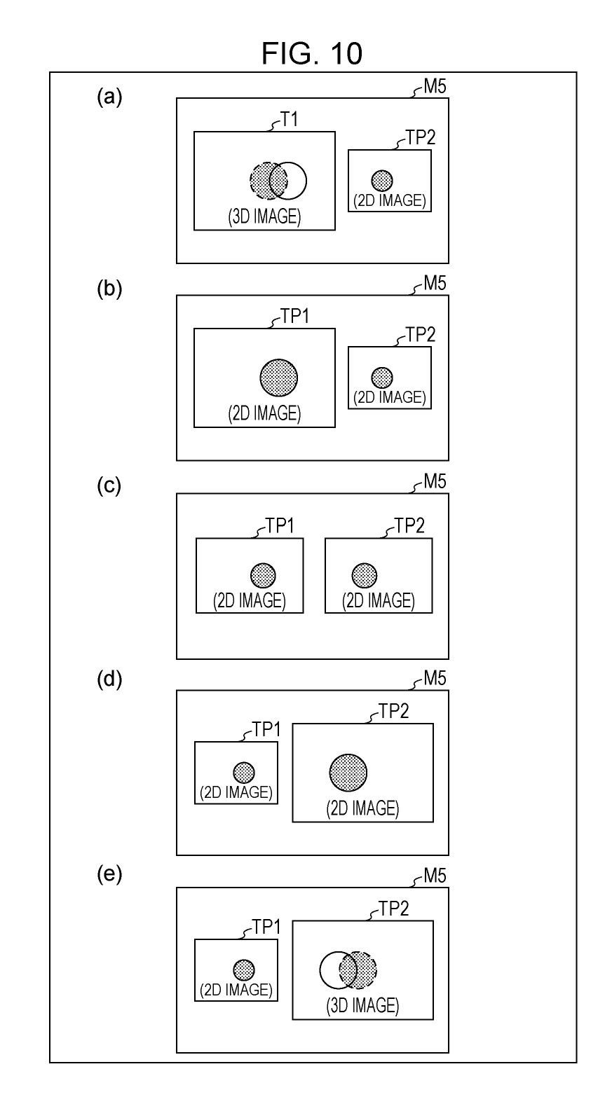

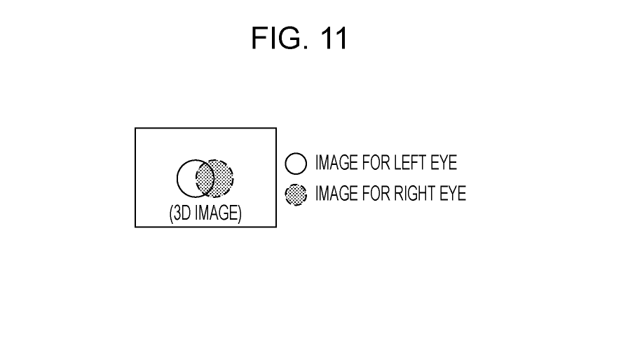

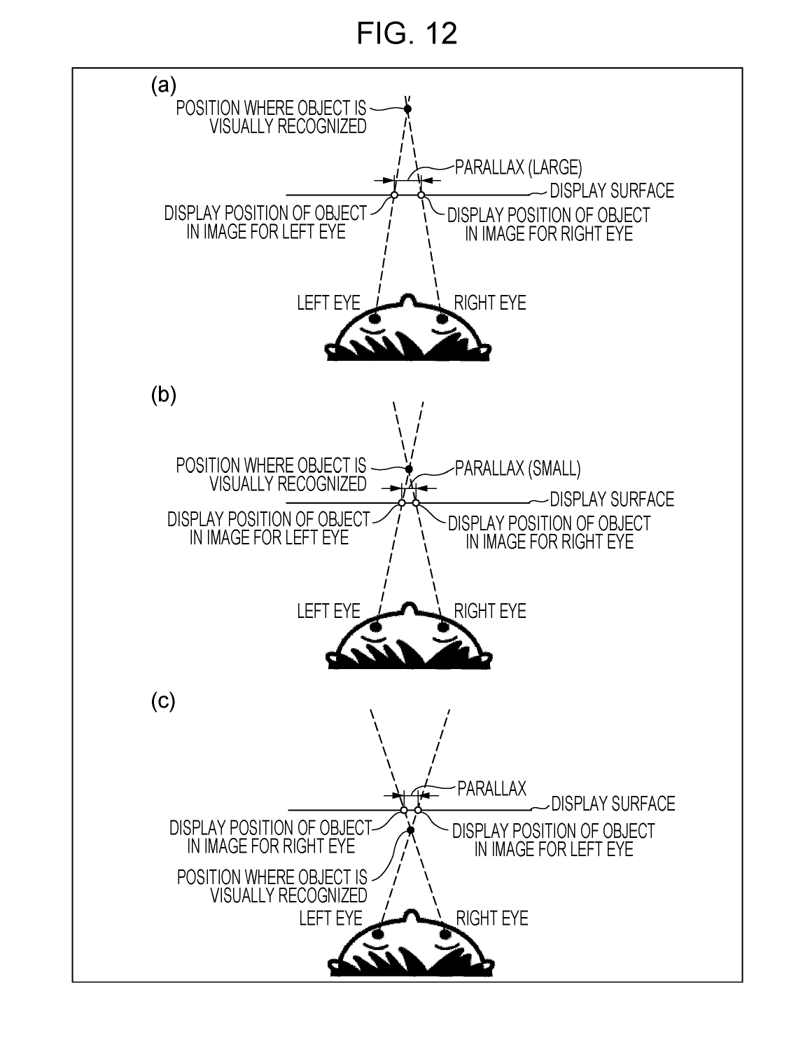

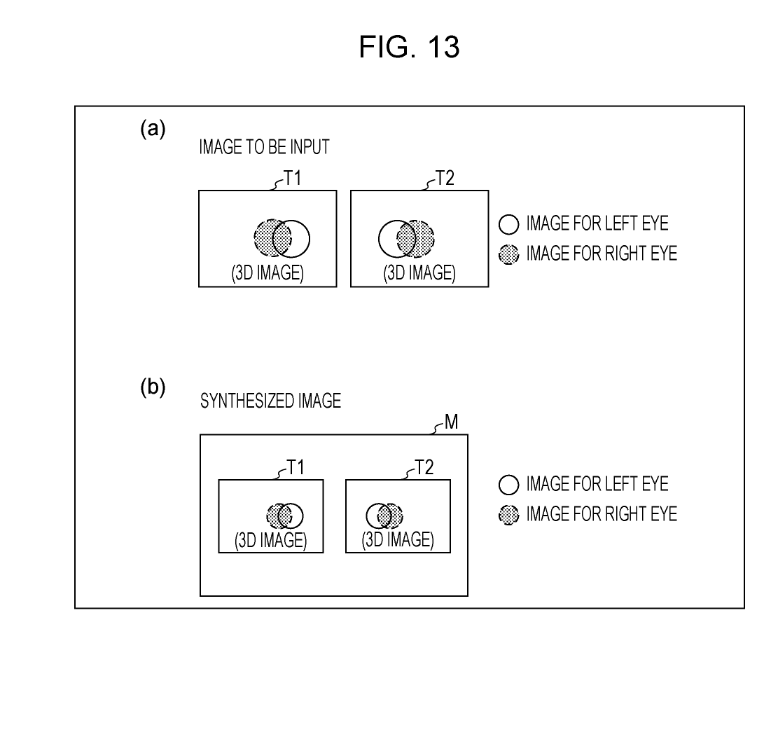

Still another embodiment of the present invention will be described below with reference to FIGS. 9 and 10. The image processing device 10 according to the present embodiment is referred to as the image processing device 10d. Additionally, for the convenience of description, members that have the same function as each member shown in Embodiments 1 and 2 will be given the same reference numerals, and descriptions thereof will be omitted except in cases in which the descriptions are specifically mentioned.

### (Configuration of Image Processing Device)

A configuration of the image processing device 10d will be described with reference to FIG. 9. FIG. 9 is a block diagram that shows a summary of the configuration of the image processing device 10d. As shown in FIG. 9, the image processing device 10d is provided with at least an image conversion unit 111, an image synthesis unit (image generation means) 152, a switching signal generation unit (attribute information acquisition means) 182 and an operation reception unit (operation input means) 191.

The operation reception unit 191 receives (1) operations from a user such as a viewer for changing a display region of each image that is synthesized in the image for display that is being displayed on the display device 20, and (2) operations that cause various menus to be displayed. The abovementioned operations can be input through an input device such as a remote control, a keyboard or a mouse. Additionally, from this point onward, in particular, cases of the abovementioned (1) will be described.

Instead of the functions that the image synthesis unit 151 is provided with, the image synthesis unit 152 is provided with a function that re-generates an image for display according to a display region that has been changed by an abovementioned operation that is received by the operation reception unit 191.

Instead of the functions that the switching signal generation unit 181 is provided with, the switching signal generation unit 182 is provided with a function that temporarily outputs all of the switching signals C1 to Cn as images for planar vision during a period in which the abovementioned operation is being received by the operation reception unit 191. As a result of this configuration, since all of the input images for stereoscopic vision are converted into images for planar vision in the image conversion unit 111, images that is synthesized in the image for display that is generated by the image synthesis unit 152 are all images for planar vision.

### (Aspect of Display)

FIG. 10 shows examples of images for display that are generated by the image processing device 10d. FIG. 10 is a drawing that schematically represents images for display that are generated by the image processing device 10d.

Firstly, FIG. 10(a) shows an example of when an operation that sets the display region is not received by the operation reception unit 191. In the example that is shown in FIG. 10(a), an image for display M5 is synthesized by setting an image (T1) that has a larger display region among the two different images for stereoscopic vision T1 and T2 as it is as an image for stereoscopic vision, and converting an image (T2) that has a smaller display region into an image for planar vision TP2.

Next, FIG. 10(b) shows a circumstance after the example shown in FIG. 10(a), and immediately after an operation that sets the display region is received by the operation reception unit 191. As shown in FIG. 10(b), synthesis is performed by respectively converting the images for stereoscopic vision T1 and T2 into images for planar vision TP1 and TP2.

Next, FIGS. 10(c) and 10(d) show circumstances after the example shown in FIG. 10(b), and during a period in which the display region is being changed as a result of the operation. As shown in FIGS. 10(c) and 10(d), synthesis is performed by respectively converting the images for stereoscopic vision T1 and T2 into images for planar vision TP1 and TP2.

Lastly, FIG. 10(e) shows a circumstance after the example shown in FIG. 10(d), and after the operation has been completed. The image for display M5 that is shown in the drawing is synthesized by setting an image (T2) that has a larger display region at the current point in time as it is as an image for stereoscopic vision, and converting an image (T1) that has a smaller display region into an image for planar vision TP1.

### (Effects)

In the manner described above, according to the image processing device 10c, in a period in which the display region of an image that is synthesized in the image for display, all of the images are displayed as image for planar vision, and images for stereoscopic vision are not displayed. Therefore, an unpleasant feeling or a feeling of discomfort is not aroused in a viewer during an operation that changes the display region.

### [Supplementary Remarks]

Lastly, each block of the image processing device 10 may be configured as hardware by a logic circuit formed on an integrated circuit (IC chip), and may be realized by software using a CPU (central processing unit).

In a case of realization using software, the image processing device 10 is provided with a CPU that executes orders of a control program that realize each function, ROM (read only memory) on which the abovementioned program is stored, RAM (random access memory) that runs the abovementioned program, recording device (recording medium) such a memory that stores the abovementioned program and various types of data and the like. Further, an object of the present invention is to also be able to achieve the invention by supplying a recording medium, on which a program code (an executable program, an intermediate code program or a source program) of a control program for the image processing device 10, which is software that realizes the abovementioned functions, is stored so as to be readable by a computer, to the abovementioned image processing device 10, and the computer (or a CPU or MPU) reading and executing the program code that is stored on the recording medium.

As the abovementioned recording medium, for example, it is possible to use a tape such as a magnetic tape or a cassette tape, a disc that includes magnetic disks such as a floppy (registered trademark) disk/hard disk and optical discs such as a CD-ROM/MO/MD/DVD/CD-R and the like, cards such as an IC card (including memory cards)/optical card, semiconductor memory such as mask ROM/EPROM/EEPROM (registered trademark)/flash ROM, or a logic circuit such as a PLD (Programmable logic device).

In addition, the image processing device 10 may be configured so as to be connectable to a communication network, and the abovementioned program code may be supplied through the communication network. The communication network is not particularly limited, and for example, it is possible to use the Internet, an intranet, an extra-net, LAN, ISDN, VAN, a CATV communication network, a virtual private network, a telephone network, a cellular line, a satellite communications network or the like. In addition, a transmission medium that configures the communication network is not particularly limited, and for example, it is possible to use fixed lines such as IEEE1394, USB, a power-line carrier, a cable TV line, and a telephone line, or an ADSL line, or wireless systems such as infrared rays like IrDA and remote controls, Bluetooth (registered trademark), IEEE802.11 wireless, HDR (High Data Rate), NFC (Near Field Communication), DLNA (Digital Living Network Alliance), a mobile telephone network, a satellite connection, and a digital terrestrial television network.

In this manner, in the present specification, means need not necessarily indicate physical means, and there are cases in which the functions of each means is realized by software. Furthermore, the function of one means may be realized by two or more physical means, and the function of two or more means may be realized by one physical means.

In the manner described above, the image processing device according to the present invention that sets a plurality of images that include at least two images for stereoscopic vision as the input thereof, generates an image for display that displays the input plurality of images simultaneously on a display unit including image conversion means that converts at least one image among the input images for stereoscopic vision into an image for planar vision; and image generation means that generates the image for display by synthesizing the image for planar vision that is converted in the image conversion means and an image among the plurality of input images that has not been converted into an image for planar vision by the image conversion means.

In addition, a control method for an image processing device that sets a plurality of images that include at least two images for stereoscopic vision as the input thereof, and generates an image for display that displays the input plurality of images simultaneously on a display unit, includes an image conversion step of converting at least one image among the input images for stereoscopic vision into an image for planar vision; and an image generation step of generating the image for display by synthesizing the image for planar vision that is converted in the image conversion step and an image among the input images that has not been converted into an image for planar vision by the image conversion step.

Therefore, it is possible to exhibit an effect of reducing the occurrence of unnatural or unpleasant displays that are caused by the parallax between the plurality of images for stereoscopic vision not coinciding, and reducing the feeling of discomfort that a viewer would feel in the related art.

Furthermore, in the image processing device according to the present invention, the images for stereoscopic vision are images that are configured by an image for the left eye for forming an image for the left eye and an image for the right eye for forming an image for the right eye, and the image conversion means may have a configuration that converts the abovementioned images for stereoscopic vision into images for planar vision by making the image for the left eye and the image for the right eye that configure an image for stereoscopic vision that is a conversion target into the same image.

According to the abovementioned configuration, it is possible to convert input images for stereoscopic vision into images for planar vision using a simple configuration.

Furthermore, in the image processing device according to the present invention, the image conversion means may have a configuration that converts the abovementioned images for stereoscopic vision into images for planar vision by replacing an image for the left eye that configures an image for stereoscopic vision that is a conversion target with an image for the right eye that configures the image for stereoscopic vision.

According to the abovementioned configuration, it is possible to convert input images for stereoscopic vision into images for planar vision using a simple configuration of replacing an image for the left eye with an image for the right eye.

Furthermore, in the image processing device according to the present invention, the image conversion means may have a configuration that converts the abovementioned images for stereoscopic vision into images for planar vision by replacing an image for the left eye that configures an image for stereoscopic vision that is a conversion target with an image for the left eye that configures the image for stereoscopic vision.

According to the abovementioned configuration, it is possible to convert input images for stereoscopic vision into images for planar vision using a simple configuration of replacing an image for the right eye with an image for the left eye.

Furthermore, in the image processing device according to the present invention, it is preferable that the image conversion means all but any one of the input images for stereoscopic vision into images for planar vision.

According to the abovementioned configuration, only one image among the input images for stereoscopic vision is displayed as an image for stereoscopic vision, and other images are displayed as images for planar vision.

Therefore, it is possible to exhibit an effect of eliminating the feeling of discomfort that a viewer would feel in the related art since unnatural or unpleasant displays that are caused by the parallax between the plurality of images for stereoscopic vision not coinciding, do not occur at all.

Furthermore, in the image processing device according to the present invention, the image conversion means may have a configuration that converts all of the images into images for planar vision except the image for stereoscopic vision in which a region that is displayed on the display unit is the largest.

According to the abovementioned configuration, only an image (a main image) that has the largest display region among the input images for stereoscopic vision is displayed as an image for stereoscopic vision, and other images (sub-images) are displayed as images for planar vision.

Furthermore, the image processing device according to the present invention may be further provided with attribute information acquisition means that acquire attribute information that is associated with the input images for stereoscopic vision, and the image conversion means may convert all of the images for stereoscopic vision into images for planar vision except images for stereoscopic vision with which the attribute information is associated when the attribute information that is acquired by the attribute information acquisition means matches predetermined conditions.

According to the abovementioned configuration, only an image among the input images for stereoscopic vision that has attribute information that matches the predetermined conditions is displayed as an image for stereoscopic vision, and other images are displayed as images for planar vision.

Furthermore, the image processing device according to the present invention may be further provided with operation input means that receive the operation of a user that changes a display region of an image that is synthesized in the image for display, the image generation means may generate an image for display in which the display region is changed depending on the operation that is received by the operation input means, and the image conversion means may convert all of the input images for stereoscopic vision into images for planar vision in a period in which an operation is being received by the operation input means.

According to the abovementioned configuration, all of the input images for stereoscopic vision are converted into images for planar vision in a period in which an operation that changes the display region of an image that is synthesized in the image for display is being received.

Accordingly, all of the input images are displayed as images for planar vision in a period in which an operation that changes the display region of an image that is synthesize in the image for display is being received.

Therefore, an unpleasant feeling or a feeling of discomfort is not aroused in a viewer during an operation that changes the display region.

Additionally, the abovementioned image processing device may be realized by a computer, and in such a case, a control program for the abovementioned image processing device that realizes the abovementioned image processing device using a computer by causing the computer to perform as the various means mentioned above, and a computer-readable recording medium on which the control program is stored fall within the scope of the present invention.

Furthermore, an integrated circuit (IC chip) that realizes the abovementioned image processing device, ROM (read only memory) on which the abovementioned control program is stored and the like also fall within the scope of the present invention.

The present invention is not limited to each of the embodiments mentioned above, various modification are possible within a range that is claimed, and embodiments that are obtained by combining respective technical means that are disclosed in different embodiments as appropriate are also included in the technical scope of the present invention.

The specific embodiments and examples that form the matters of the detailed specification of the invention merely used to clarify the technical content of the present invention. The invention should not be interpreted in a narrow sense as being limited to such specific examples, and various changes can be implemented within the spirit of the present invention and the range of the claims that are recited below.

### INDUSTRIAL APPLICABILITY

The present invention can be suitably applied to an image processing device that generates an image for display that displays a plurality of image for stereoscopic vision simultaneously on a display device. In addition, the present invention can be suitably applied to a display device that displays a plurality of image for stereoscopic vision simultaneously.

### REFERENCE SIGNS LIST

10, 10a to 10d image processing device
11_1 to 11_{—}n conversion unit
20 display device (display unit)
1111, 112 image conversion unit (image conversion means)
121 image separation unit
141, 142 image assimilation unit
151, 152 image synthesis unit (image generation means)
181, 182 switching signal generation unit
191 operation reception unit (operation input means)
T1 to Tn image for stereoscopic vision
M1 to M5 image for display
TL1 to TLn image for the left eye
TR1 to TRn image for the right eye

1. An image processing device that receives a plurality of individual images including at least two images that form a stereoscopic image and generates a display image displaying the plurality of input individual images simultaneously on a display unit, the image processing device comprising:
image conversion means that converts at least one image among the input images that form the stereoscopic image into a planar image; and
image generation means that generates the display image by synthesizing the planar image that has been converted by the image conversion means and an image among the plurality of input images that has not been converted into a planar image by the image conversion means.

2. The image processing device according to claim 1, wherein
the stereoscopic image is configured to have an image for a left eye viewing left and an image for a right eye viewing right, and
the image conversion means converts the stereoscopic image into a planar image by making the image for the left eye and the image for the right eye the same, which configure a stereoscopic image to be converted.

3. The image processing device according to claim 2,
wherein the image conversion means converts the stereoscopic image into a planar image by replacing the image for the left eye, which configures the stereoscopic image to be converted with an image that is the same as the image for the right eye, which configures the stereoscopic image to be converted.

4. The image processing device according to claim 2,
wherein the image conversion means converts the stereoscopic image into a planar image by replacing the image for the left eye, which configures the stereoscopic image to be converted with an image that is the same as the image for the left eye, which configures the stereoscopic image to be converted.

5. The image processing device according to claim 1,
wherein the image conversion means converts all of the input stereoscopic images except a stereoscopic image among the input stereoscopic images into planar images.

6. The image processing device according to claim 5,
wherein, the image conversion means converts all of the input stereoscopic images except a stereoscopic image that is the largest in size on the display unit among the input stereoscopic images into planar images.

7. The image processing device according to claim 5 further comprising:
attribute information acquisition means that acquires attribute information that is associated with the input stereoscopic images,
wherein the image conversion means converts all of the stereoscopic images except a stereoscopic image that is associated with the attribute information into planer images when the attribute information that is acquired by the attribute information acquisition means matches predetermined conditions.

8. The image processing device according to claim 1 further comprising:
operation input means that receives an operation by a user and changes a display region of an image that is synthesized in the display image, wherein
the image generation means generates the display image having a display region that is changed according to the operation received by the operation input means, and
the image conversion means converts all of the input stereoscopic images into planar images in a period in which the operation is being received by the operation input means.

9. A method for controlling an image processing device that receives a plurality of individual images including at least two images that form a stereoscopic image and generates a display image displaying the plurality of input individual images simultaneously on a display unit, the controlling method comprising:
an image conversion step of converting at least one image among the input images that form the stereoscopic image into a planar image; and
an image generation step of generating the display image by synthesizing the planar image that has been converted in the image conversion step and an image among the plurality of input images that has not been converted into a planar image in the image conversion step.

10. A control program that causes a computer to operate that is included in the image processing device according to claim 1,
wherein the control program causes the computer to function as each of the means.

11. A computer-readable recording medium on which the control program according to claim 10 is recorded.
